(19) United States
(12) Patent Application Publication
(10) Pub. No.: US 2019/0139355 A1
(43) Pub. Date: May 9, 2019

(54) Shampoo Dispensing Assembly

(71) Applicant: Vince Kong, Las Vegas, NV (US)

(72) Inventor: Vince Kong, Las Vegas, NV (US)

(21) Appl. No.: 15/802,522

(22) Filed: Nov. 3, 2017

(51) Int. Cl. G07F 13/06; B65B 3/04; B67D 7/22; B67D 7/78

(52) U.S. Cl. CPC G07F 13/06; B65B 3/04; G06Q 99/00; B67D 7/78; B67D 7/22

(57) ABSTRACT

A shampoo dispensing assembly for refilling shampoo bottles includes a housing that may be positioned on a support surface. A plurality of dispensers is provided and each of the dispensers is positioned within the housing. Each of the dispensers contains a fluid soap. Moreover, each of the dispensers is selectively turned on to dispense a selected amount of the fluid soap for refilling a shampoo bottle. A control is coupled to the housing and the control is electrically coupled to each of the dispensers to turn each of the dispensers on and off. The control actuates the dispensers to dispense a selected amount of the fluid soap.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to dispensing devices and more particularly pertains to a new dispensing device for refilling shampoo bottles.

### BRIEF SUMMARY OF THE INVENTION

An embodiment of the disclosure meets the needs presented above by generally comprising a housing that may be positioned on a support surface. A plurality of dispensers is provided and each of the dispensers is positioned within the housing. Each of the dispensers contains a fluid soap. Moreover, each of the dispensers is selectively turned on to dispense a selected amount of the fluid soap for refilling a shampoo bottle. A control is coupled to the housing and the control is electrically coupled to each of the dispensers to turn each of the dispensers on and off. The control actuates the dispensers to dispense a selected amount of the fluid soap.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a shampoo dispensing assembly according to an embodiment of the disclosure.

FIG. 2 is a front view of an embodiment of the disclosure.

FIG. 3 is a back phantom view of an embodiment of the disclosure.

FIG. 4 is a cross sectional view taken along line 4-4 of FIG. 2 of an embodiment of the disclosure.

### DETAILED DESCRIPTION OF THE INVENTION

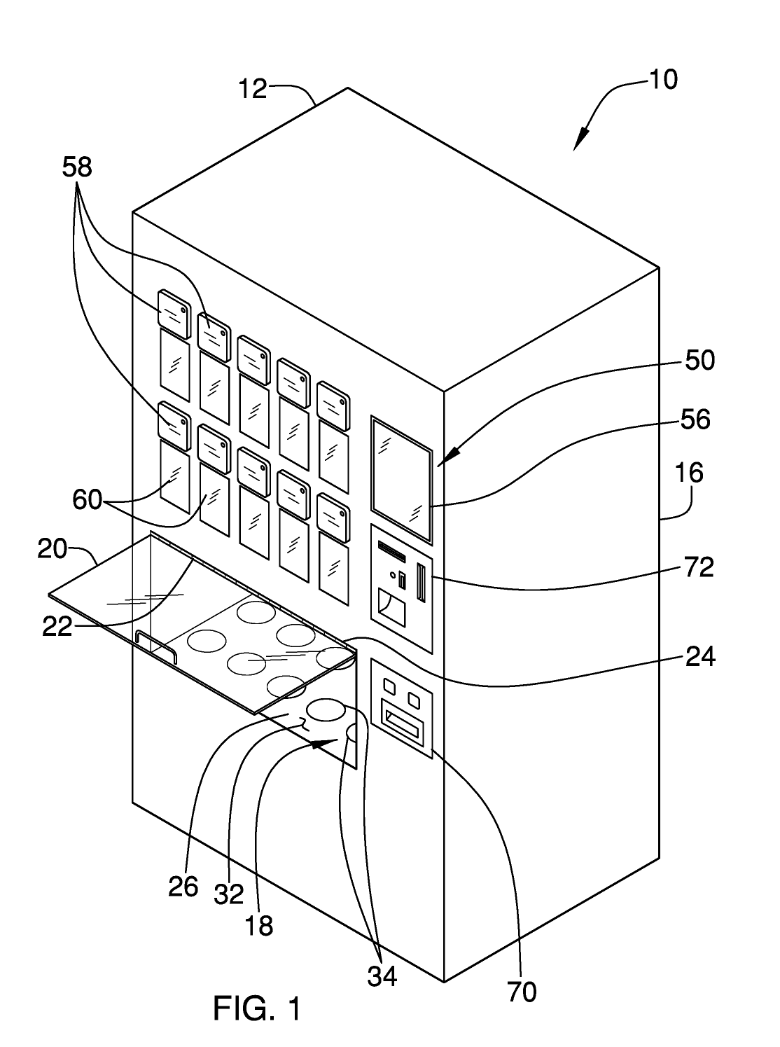

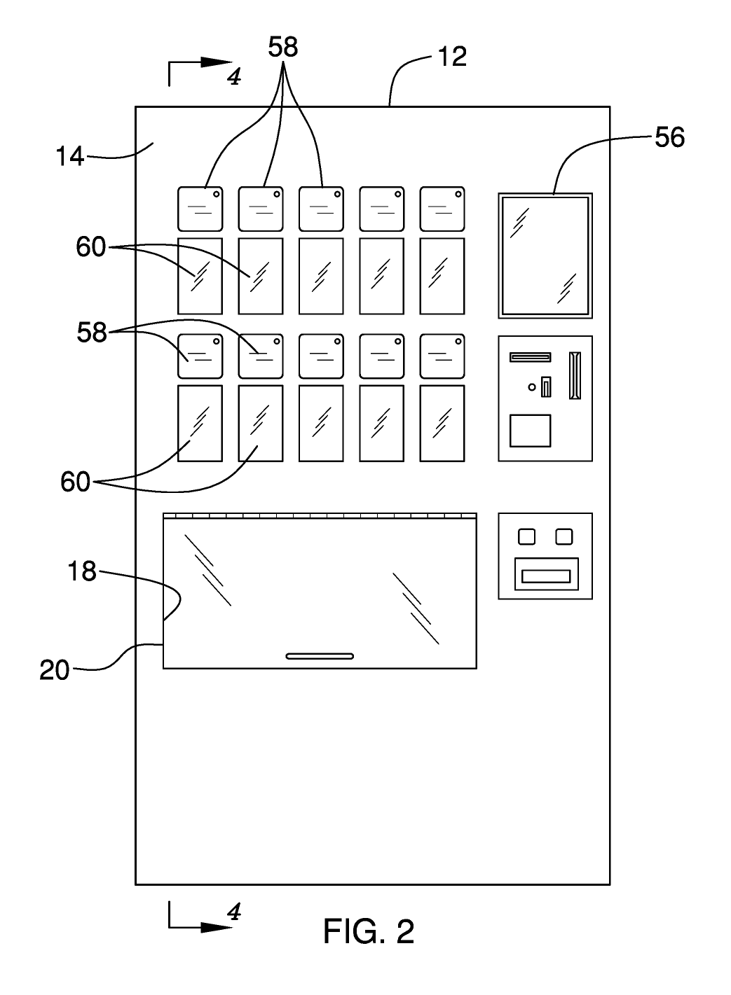

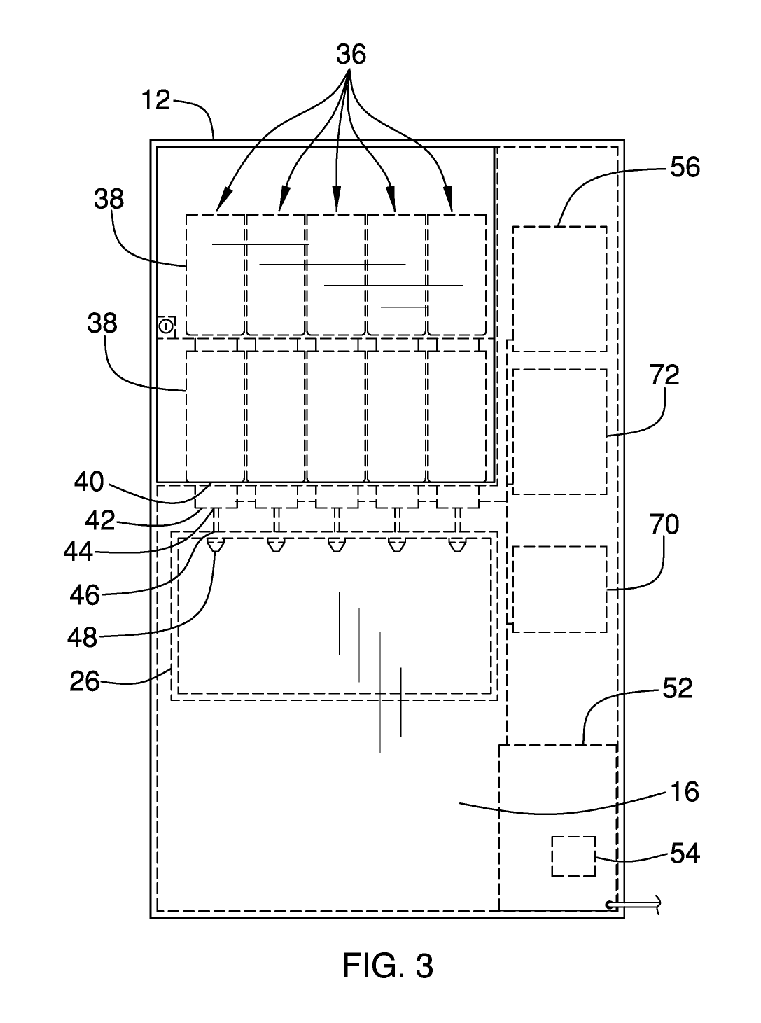

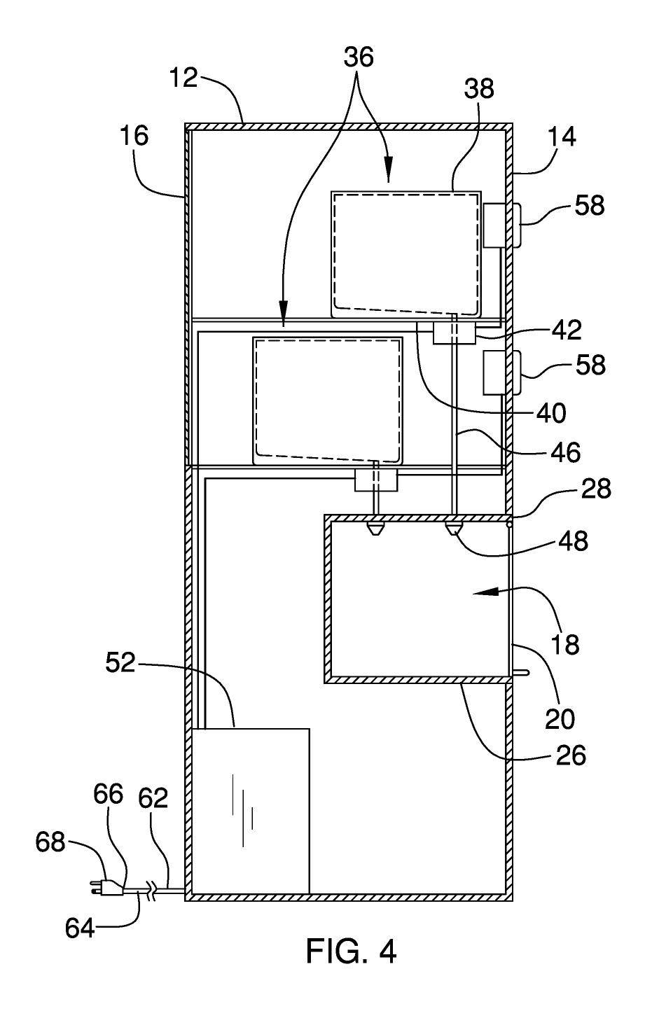

With reference now to the drawings, and in particular to FIGS. 1 through 4 thereof, a new dispensing device embodying the principles and concepts of an embodiment of the disclosure and generally designated by the reference numeral 10 will be described.

As best illustrated in FIGS. 1 through 4, the shampoo dispensing assembly 10 generally comprises a housing 12 that may be positioned on a support surface. The housing 12 has a front wall 14, a back wall 16 and the housing 12 is substantially hollow. The front wall 14 has an aperture 18 extending into an interior of the housing 12. The housing 12 may be positioned in a retail environment, such as a department store or the like. The back wall 16 is hingedly coupled to the housing 12 to access an interior of the housing 12.

A door 20 is hingedly coupled to the housing 12 the door 20 is positioned to close the aperture 18. The aperture 18 has a bounding edge 22 and the door 20 has a peripheral edge 24. The peripheral edge 24 is hingedly coupled the bounding edge 22. A handle is coupled to the door 20 for opening and closing the door 20. The door 20 may be comprised of a translucent material such as clear plastic or the like.

A box 26 is positioned within the housing 12 and the box 26 has a front side 28 and a top side 30. The front side 28 is open and the front side 28 is aligned with the aperture 18. In this way a shampoo bottle is selectively positioned in the box 26. The box 26 has an inside surface 32 and indicia 34 may be printed on the inside surface 32. The indicia 34 may comprise a plurality of circles and the shampoo bottle is positioned on a selected one of the circles when the shampoo bottle is positioned in the box 26.

A plurality of dispensers 36 is provided and each of the dispensers 36 is positioned within the housing 12. Each of the dispensers 36 contains a fluid soap such as shampoo for bathing or the like. Each of the dispensers 36 is selectively turned on to dispense a selected amount of the fluid soap to refill the shampoo bottle. In this way eco-conscious individuals may refill the shampoo bottle rather than purchasing a new shampoo bottle.

Each of the dispensers 36 comprises a reservoir 38 that is positioned within the housing 12. The reservoir 38 contains the fluid soap and the reservoir 38 is vertically oriented in the housing 12 such that the reservoir 38 is gravity fed. The reservoir 38 has a bottom wall 40 and the reservoir 38 is positioned above the box 26. A pump 42 is coupled to the bottom wall 40 of the reservoir 38. The pump 42 is in fluid communication with an interior of the reservoir 38 to selectively urge the fluid soap outwardly from the reservoir 38. The pump 42 has an outlet 44 and the pump 42 may be an electric fluid pump 42 or the like.

A nozzle 46 is fluidly coupled to the outlet 44 and the nozzle 46 has a distal end 48 with respect to the pump 42. The distal end 48 is open to selectively dispense the fluid soap. The nozzle 46 extends through the top side 30 of the box 26 and the distal end 48 is positioned within the box 26. Thus, the distal end 48 directs the fluid soap into the shampoo bottle when the shampoo bottle is positioned in the box 26. Additionally, the nozzle 46 corresponding to each of the dispensers 36 is aligned with an associated one of the circles on the box 26.

A control 50 is coupled to the housing 12 and the control 50 is electrically coupled to each of the dispensers 36. The control 50 turns each of the dispensers 36 on and off. The control 50 actuates the dispensers 36 to dispense a selected amount of the fluid soap in a selected one of the reservoir 38s. In this way a shampoo bottle of a selected size may be selectively refilled with a selected type of shampoo.

The control 50 comprises a processor 52 that is positioned within the housing 12. The processor 52 selectively generates a dispensing sequence. Additionally, the processor 52 is electrically coupled to the pump 42 corresponding to each of the dispensers 36. The processor 52 turns the pump 42 corresponding to each of the dispensers 36 on and off when the processor 52 generates the dispensing sequence. Moreover, the processor 52 includes an electronic memory 54 and the electronic memory 54 contains a database pertaining to the plurality of dispensers 36.

A display 56 is coupled to the front wall 14 of the housing 12 for displaying indicia 34. The display 56 is electrically coupled to the processor 52 and the display 56 displays operational parameters of the processor 52. The display 56 may comprise an LCD or the like. A plurality of buttons 58 is provided. Each of the buttons 58 is movably coupled to the front wall 14 of the housing 12 and each of the buttons 58 is selectively manipulated.

Each of the buttons 58 is electrically coupled to the processor 52. The processor 52 generates the dispensing sequence when a selected one of the buttons 58 is manipulated. Moreover, each of the buttons 58 is assigned to the pump 42 of an associated one of the dispensers 36. Thus, the processor 52 turns on the pump 42 of the associated dispenser when a corresponding one of the buttons 58 is manipulated.

A plurality of labels 60 is provided and each of the labels 60 is positioned on the front wall 14 of the housing 12. Additionally, each of the labels 60 is aligned with an associated one of the buttons 58. Each of the labels 60 identifies a type of the fluid soap that is associated with each of the buttons 58. Thus, a user may choose a type of the fluid soap to be dispensed.

A power supply 62 is coupled to the housing 12 and the power supply 62 is electrically coupled the processor 52. The power supply 62 includes a power cord 64 extending away from the housing 12. The power cord 64 has a distal end 66 with respect to the housing 12 and a plug 68 is electrically coupled to the distal end 66 of the power cord 64. The plug 68 is selectively and electrically coupled to a power source such as a female electrical outlet 44 or the like.

A label printer 70 is coupled to the front wall 14 of the housing 12 and the label printer 70 selectively prints labels 60. The label printer 70 is electrically coupled to the processor 52 such that the processor 52 turns the label printer 70 on and off. Moreover, the label printer 70 prints a label corresponding to the fluid soap and a selected one of the dispensers 36 for identifying the fluid soap in the shampoo bottle. The label printer 70 may be an electronic label printer 70 of any conventional design.

A currency unit 72 is provided and the currency unit 72 is coupled the front wall 14 of the housing 12. The currency unit 72 is electrically coupled the processor 52 and the currency unit 72 processes a monetary payment corresponding to the fluid soap dispensed into the shampoo bottle. The currency unit 72 may include a credit card reader and a currency slot. Additionally, the currency unit 72 may be in wireless electrical communication with an extrinsic communication network, such as a financial institution or the like, for processing electronic payments. The currency unit 72 may be an electronic currency unit 72 of any conventional design.

In use, the door 20 is opened and the shampoo bottle is positioned in the box 26. Moreover, the shampoo bottle is positioned on one of the circles that corresponds to a selected one of the buttons 58. The selected button 58 is manipulated to dispense a selected amount of the fluid soap in a selected one of the reservoir 38s. In this way an environmentally conscious consumer may refill a shampoo bottle rather than purchasing a new shampoo bottle. The back wall 16 of the housing 12 is selectively opened for refilling the reservoir 38s and for servicing the dispensing unit.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A shampoo dispensing assembly being configured to selectively refill a shampoo container, said assembly comprising:
a housing being configured to be positioned on a support surface;
a plurality of dispensers, each of said dispensers being positioned within said housing, each of said dispensers being configured to contain a fluid soap, each of said dispensers being selectively turned on to dispense a selected amount of the fluid soap wherein said dispensers are configured to refill a shampoo bottle; and
a control being coupled to said housing wherein said control is configured to be manipulated, said control being electrically coupled to each of said dispensers such that said control turns each of said dispensers on and off wherein said control is configured to dispense a selected amount of the fluid soap in a selected one of said dispensers.

2. The assembly according to claim 1, wherein said housing has a front wall, said housing being substantially hollow, said front wall having an aperture extending into an interior of said housing.

3. The assembly according to claim 2, further comprising a box being positioned within said housing, said box having a front side and the top side, said front side being open, said front side being aligned with said aperture wherein said box is configured to have the shampoo bottle positioned therein.

4. The assembly according to claim 2, further comprising a door being hingedly coupled to said housing wherein said door is configured to be manipulated, said door being positioned to close said aperture, said aperture having a bounding edge, said door having a peripheral edge, said peripheral edge being hingedly coupled said bounding edge.

5. The assembly according to claim 4, further comprising a handle being coupled to said door wherein said handle is configured to be gripped for opening and closing said door.

6. The assembly according to claim 3, wherein each of said dispensers comprises a reservoir being positioned within said housing, said reservoir being configured to contain the fluid soap, said reservoir being vertically oriented in said housing wherein said reservoir is configured to be gravity fed, said reservoir having a bottom wall, said reservoir being positioned above said box.

7. The assembly according to claim 6, further comprising a pump being coupled to said bottom wall of said reservoir, said pump being in fluid communication with an interior of said reservoir wherein said pump is configured to selectively urge the fluid soap outwardly from said reservoir, said pump having an outlet.

8. The assembly according to claim 7, further comprising a nozzle being fluidly coupled to said outlet, said nozzle having a distal end with respect to said pump, said distal end being open wherein said nozzle is configured to selectively dispense the fluid soap.

9. The assembly according to claim 8, wherein said nozzle extends through said top side of said box having said distal end being positioned within said box wherein said distal end is configured to direct the fluid soap into the shampoo bottle.

10. The assembly according to claim 7, wherein said control comprises a processor being positioned within said housing, said processor selectively generating a dispensing sequence, said processor being electrically coupled to said pump corresponding to each of said dispensers such that said processor turns said pump corresponding to each of said dispensers on and off when said processor generates said dispensing sequence.

11. The assembly according to claim 10, wherein said processor includes an electronic memory, said electronic memory containing a database pertaining to said plurality of dispensers.

12. The assembly according to claim 10, further comprising a display being coupled to said front wall of said housing wherein said display is configured to be viewed, said display being electrically coupled to said processor wherein said display displays operational parameters of said processor.

13. The assembly according to claim 10, further comprising a plurality of buttons, each of said buttons being movably coupled to said front wall of said housing wherein each of said buttons is configured to be selectively manipulated, each of said buttons being electrically coupled to said processor, said processor generating said dispensing sequence when a selected one of said buttons is manipulated.

14. The assembly according to claim 13, wherein each of said buttons being assigned to said pump of an associated one of said dispensers such that said processor turns on said pump of said associated dispenser when a corresponding one of said buttons is manipulated.

15. The assembly according to claim 10, further comprising a power supply being coupled to said housing, said power supply being electrically coupled said processor, said power supply including a power cord extending away from said housing, said power cord having a distal end with respect to said housing, said distal end having a plug being electrically coupled thereto, said plug being configured to be electrically coupled to a power source.

16. The assembly according to claim 10, further comprising a label printer being coupled to said front wall of said housing wherein said label printer is configured to selectively print labels, said label printer being electrically coupled to said processor such that said processor turns said label printer on and off, said label printer printing a label corresponding to the fluid soap and a selected one of said dispensers for identifying the fluid soap in the shampoo bottle.

17. The assembly according to claim 10, further comprising a currency unit being coupled said front wall of said housing wherein said currency unit is configured to be manipulated, said currency unit being electrically coupled said processor, said currency unit being configured to receive a monetary payment corresponding to the fluid soap dispensed into the shampoo bottle.

18. A shampoo dispensing assembly being configured to selectively refill a shampoo container, said assembly comprising:
a housing being configured to be positioned on a support surface, said housing having a front wall, said housing being substantially hollow, said front wall having an aperture extending into an interior of said housing;
a door being hingedly coupled to said housing rancid doors configured to be manipulated, said door being positioned to close said aperture, said aperture having abounding edge, said door having a peripheral edge, said peripheral edge being hingedly coupled said bounding edge;
a handle being coupled to said door wherein said handle is configured to be gripped for opening and closing said door;
a box being positioned within said housing, said box having a front side and the top side, said front side being open, said front side being aligned with said aperture wherein said box is configured to have the shampoo bottle positioned therein;
a plurality of dispensers, each of said dispensers being positioned within said housing, each of said dispensers being configured to contain a fluid soap, each of said dispensers being selectively turned on to dispense a selected amount of the fluid soap wherein said dispensers are configured to refill a shampoo bottle, each of said dispensers comprising:
a reservoir being positioned within said housing, said reservoir being configured to contain the fluid soap, said reservoir being vertically oriented in said housing wherein said reservoir is configured to be gravity fed, said reservoir having a bottom wall, said reservoir being positioned above said box,
a pump being coupled to said bottom wall of said reservoir, said pump being in fluid communication with an interior of said reservoir wherein said pump is configured to selectively urge the fluid soap outwardly from said reservoir, said pump having an outlet, and
a nozzle being fluidly coupled to said outlet, said nozzle having a distal end with respect to said pump, said distal end being open wherein said nozzle is configured to selectively dispense the fluid soap, said nozzle extending through said top side of said box having said distal end being positioned within said box wherein said distal end is configured to direct the fluid soap into the shampoo bottle;
a control being coupled to said housing wherein said control is configured to be manipulated, said control being electrically coupled to each of said dispensers such that said control turns each of said dispensers on and off wherein said control is configured to dispense a selected amount of the fluid soap in a selected one of said reservoirs, said control comprising:
a processor being positioned within said housing, said processor selectively generating a dispensing sequence, said processor being electrically coupled to said pump corresponding to each of said dispensers such that said processor turns said pump corresponding to each of said dispensers on and off when said processor generates said dispensing sequence, said processor including an electronic memory, said electronic memory containing a database pertaining to said plurality of dispensers,
a display being coupled to said front wall of said housing wherein said display is configured to be viewed, said display being electrically coupled to said processor wherein said display displays operational parameters of said processor,
a plurality of buttons, each of said buttons being movably coupled to said front wall of said housing wherein each of said buttons is configured to be selectively manipulated, each of said buttons being electrically coupled to said processor, said processor generating said dispensing sequence when a selected one of said buttons is manipulated, each of said buttons being assigned to said pump of an associated one of said dispensers such that said processor turns on said pump of said associated dispenser when a corresponding one of said buttons is manipulated, and
a power supply being coupled to said housing, said power supply being electrically coupled said processor, said power supply including a power cord extending away from said housing, said power cord having a distal end with respect to said housing, said distal end having a plug being electrically coupled thereto, said plug being configured to be electrically coupled to a power source;
a label printer being coupled to said front wall of said housing wherein said label printer is configured to selectively print labels, said label printer being electrically coupled to said processor such that said processor turns said label printer on and off, said label printer printing a label corresponding to the fluid soap and a selected one of said dispensers for identifying the fluid soap in the shampoo bottle; and
a currency unit being coupled said front wall of said housing wherein said currency unit is configured to be manipulated, said currency unit being electrically coupled said processor, said currency unit being configured to receive a monetary payment corresponding to the fluid soap dispensed into the shampoo bottle.
